(19) United States
(12) Patent Application Publication
(10) Pub. No.: US 2022/0172247 A1
(43) Pub. Date: Jun. 2, 2022

(54) METHOD, APPARATUS AND PROGRAM FOR CLASSIFYING SUBJECT MATTER OF CONTENT IN A WEBPAGE

(71) Applicant: Silver Bullet Media Services Limited, London (GB)

(72) Inventors: Alex ROSEN, London (GB); Darren MOONEY, Plymouth (GB); Nathan OLIVER, Plymouth (GB); Umberto TORRIELLI, Weston, CT (US)

(21) Appl. No.: 17/537,849

(22) Filed: Nov. 30, 2021

(30) Foreign Application Priority Data
Dec. 2, 2020 (GB) 2019029.4

(51) Int. Cl. G06Q 30/02; G06F 16/33; G06F 16/35

(52) U.S. Cl. CPC G06Q 30/0253; G06F 16/35; G06F 16/3334; G06Q 30/0277

(57) ABSTRACT

A method and an information processing apparatus for classifying subject matter of content in a webpage are described. The method comprises receiving a webpage, extracting content from the webpage and identifying keywords from the extracted content. The keywords are identified based on keywords contained in a taxonomy stored by the information processing apparatus that associates the keywords with categories of subject matter. The information processing apparatus assigns an importance score to the keywords identified from the extracted content. Context scores associated with categories or subcategories of subject matter within the taxonomy are calculated based on the importance scores of the identified keywords. The content is classified as being associated with the category of subject matter based on the context scores.

### CROSS REFERENCE TO RELATED APPLICATIONS

This application claims priority under 35 U.S.C. § 119(a) and 37 CFR § 1.55 to GB patent application no. 2019029.4, filed on Dec. 2, 2020, the entire content of which is incorporated herein by reference.

### BACKGROUND

### Technical Field

The present invention relates to a method, apparatus and program for classifying subject matter of content in a webpage.

### Background

A source of revenue for publishers of websites on the internet is digital advertising, in which the website owner sells ad slots on webpages to customers who pay to display content on the webpages to website users. In order to facilitate this process, an infrastructure has been created to allow publishers to sell space on their webpages and for customers to purchase space on webpages to display content.

Publishers can make inventory (ad slots on pages to be served to website users) available to multiple potential customers via a supply-side platforms (SSP). On the other side, potential customers can bid for inventory via demand-side platforms (DSP). Between the SSP and DSP exists a digital exchange that facilitates the buying and selling of inventory.

The use of programmatic advertising helps to more efficiently place content in different ad slots. However, problems can arise with content being placed inappropriately. For example, an undergarment retailer may wish to place content on webpages relating to fashion or lifestyle, but not wish their content to appear on webpages including content for children or religious content. Many brands will want to avoid their content appearing on webpages relating to topics such as drugs or terrorism.

### SUMMARY

According to a first aspect of the present invention, there is provided a method performed by an information processing apparatus for classifying subject matter of content in a webpage comprising: receiving a webpage; extracting content from the webpage; identifying keywords from the extracted content, wherein the keywords are also contained in a taxonomy stored by the information processing apparatus that associates the keywords with categories of subject matter; assigning an importance score to the keywords identified from the extracted content; calculating context scores associated with categories or subcategories of subject matter within the taxonomy based on the importance scores of the identified keywords; and classifying the content as being associated with one or more category or subcategory of subject matter based on the context scores.

In some embodiments the content in the webpage includes text and the method further comprises a step of normalising the text. In some such embodiments, the step of extracting content from the webpage may comprise extracting text content from the webpage using one of a plurality of methods for extracting content from the webpage. The method for extracting text content from the webpage may be selected from the plurality of methods for extracting content using a machine learning model based on a type of webpage structure.

The step of calculating context scores may comprise a step of additively combining importance scores of keywords identifies within a category or sub-category. The step may further include normalising the additive combination to generate a context score.

In other embodiments the content in the webpage includes video data and the method further comprises separating audio data and visual data from the video and the step of identifying keywords using the extracted content comprises extracting keywords from the audio data using speech recognition and extracting keywords from the visual data using image recognition. In such embodiments, the step of calculating context scores may comprise calculating context scores for the webpage based on importance scores of keywords, which keywords include keywords extracted from the audio data and keywords extracted from the visual data. In some implementations the context scores are calculating from a weighted combination of importance scores of keywords associated with the visual data and the audio data. In some implementations keyword importance scores are calculated based on a confidence score of a speech recognition program used to extract keywords from the audio data and/or based on a confidence score of an image recognition program used to extract keywords from the visual data. The confidence values from the speech recognition program and/or image recognition program may be adjusted using a word embedding model that compares a similarity of an identified keyword with other extracted keywords.

In some embodiments the webpage includes both video content and text content. In such embodiments, instances of keywords extracted from both the video content and the text content may be analysed in combination to generate an importance score for the keywords.

The importance score of a keyword may be determined based on a frequency of occurrence of a word within the identified keywords. The importance score of a keyword may be determined based on a measure of frequency of keyword usage in a reference language data set. In some embodiments, the importance score may be based on a measurement of term-frequency inverse document frequency.

The method may comprise the step of generating the taxonomy, wherein the step of generating the taxonomy comprises a step of automatically extracting keywords from one or more data sources. In such embodiments the method may comprise a step of displaying keywords extracted from one or more data sources to a user to enable selection of keywords to be added to the taxonomy. The one or more data sources may be one or more webpages. The one or more data sources may include data obtained from one or more of a social media service, a web analytics service, and a customer data management system.

The method may comprise automatically populating a taxonomy with keywords and categories or subcategories based on keywords extracted from the one or more data sources.

The method may comprise a step of expanding seed content of a data source using a generative transformer, wherein automatically extracting keywords from the one or more data source comprises automatically extracting keywords from the expanded content of the data source.

The method may include a step of sending a signal including an indication of the subject matter classification to at least one of a demand-side platform and a supply-side platform within a system for automated placement of digital content within webpages.

According to a second aspect of the present invention there is provided an information processing apparatus for classifying subject matter of content in a webpage, wherein the information processing apparatus is configured to: receive a webpage; extract content from the webpage; identify keywords from the extracted content, wherein the keywords are also contained in a taxonomy stored by the information processing apparatus that associates the keywords with categories of subject matter; assign an importance score to the keywords identified from the extracted content; calculate context scores associated with categories or subcategories of subject matter within the taxonomy based on the importance scores of the identified keywords; and classify the content as being associated with one or more category or subcategory of subject matter based on the context scores.

According to a third aspect of the present invention there is provided a program that, when executed by an information processing apparatus, causes the information processing apparatus to perform a method according to the first aspect of the invention.

According to a further aspect of the present invention there is provided a method of generating a taxonomy comprising: extracting keywords from one or more data sources; and forming a taxonomy using the extracted keywords. In some implementations, the method comprises automatically populating a taxonomy with keywords and categories based on keywords extracted from the one or more data sources.

According to a further aspect of the present invention there is provided a taxonomy wherein the taxonomy is generated by a method comprising: extracting keywords from one or more data sources; and forming a taxonomy using the extracted keywords.

A further aspect of the present invention provides a demand-side platform comprising a taxonomy according to the preceding aspect of the invention. The demand-side platform may be configured to send a request to an information processing apparatus to determine whether or not the content of a webpage includes subject matter identified within the taxonomy, wherein the request includes an identification of subject matter from the taxonomy.

The demand-side platform may be configured to allow a customer to select subject matter from the taxonomy during a process of creating a campaign for purchasing ad slots. The step of allowing a customer to select subject matter from the taxonomy may comprise a further step of displaying to the user webpages associated with a user selection of subject matter from the taxonomy in order to allow the user to confirm their selection.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagram of a webpage;

FIG. 2 is a schematic diagram of an architecture of a system for placing content;

FIG. 3 is a schematic diagram of an alternative architecture of a system for placing content;

FIG. 4 is a flowchart showing steps for categorising content in the architecture shown in FIG. 2;

FIG. 5 is a flowchart showing steps for categorising content in the architecture shown in FIG. 3;

FIG. 6 shows a portion of a taxonomy;

FIG. 7 is a flowchart showing a method for classifying text content within a webpage;

FIG. 8 is a flowchart showing a method for classifying video content within a webpage; and

FIG. 9 is a flow chart showing a method for keyword discovery from a webpage.

### DETAILED DESCRIPTION

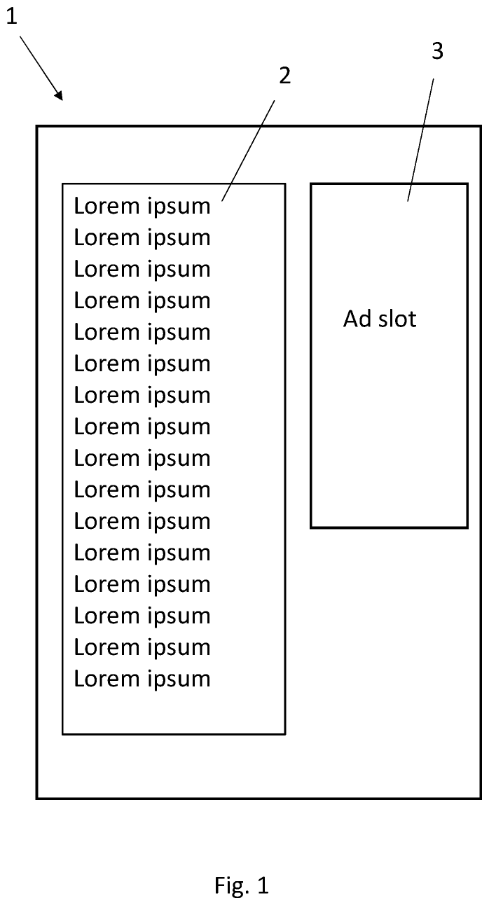

FIG. 1 is a diagram of a webpage 1 which includes some content 2 and an ad slot for including paid content. The webpage 1 is stored on a web server and may be served to a user computer in response to a request to access the webpage. For example, the webpage may be a page of a local newspaper including some local news content with an ad slot provided on one side of the webpage.

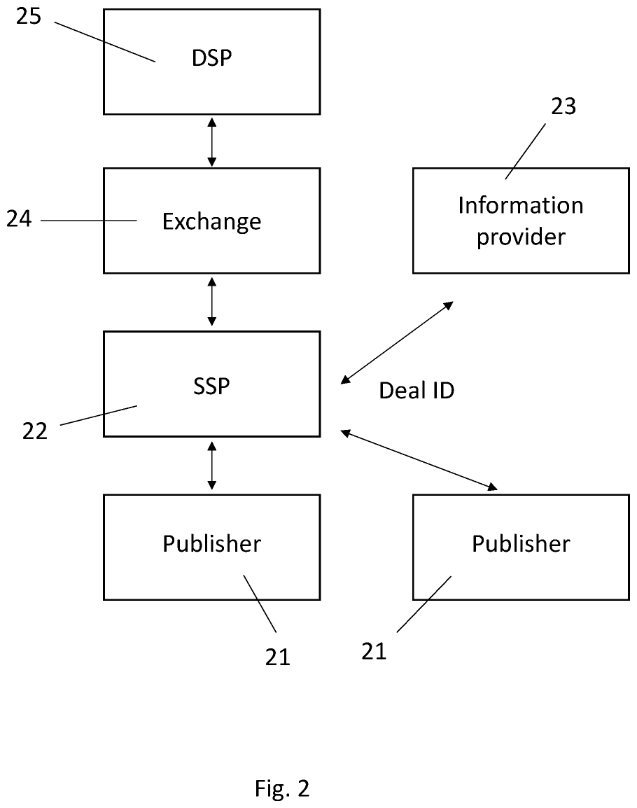

A system for placing content within webpages is shown in FIG. 2. A publisher server 21 (hereinafter “publisher”) storing webpages on a webserver is shown in FIG. 2. In one example, the publisher 21 is owned by a local newspaper that has local news content in a webpage and wishes to obtain a paid content to be included in the webpage alongside the news content. When the publisher 21 receives a request to access the webpage, the publisher 21 contacts a supply-side platform (hereinafter ‘SSP’) 22. The publisher 21 sends a message to the SSP 22 to indicate that the publisher 21 has an available ad slot and includes a URL of the webpage in which paid content may be included. The publisher 21 may also provide other information to the SSP 22 such as an identity of the user that requested a web page to be served. The SSP 22 aggregates requests for content from many publishers 21.

The SSP 22 contacts an information provider 23 and receives information about the subject matter of the webpage, as will be described in more detail below.

The supply-side platform 22 sends a bid request for inventory of ad slots within webpages to at least one demand-side platform 25 (hereinafter ‘DSP’) via an exchange 24. The exchange facilitates the process by, for example, sending the bid request to several DSP 25. The bid request includes information such as an identification of the user requesting the webpage, location of the user, subject matter of the webpage etc.

The DSP 25 receives the bid request and compares the information in the bid request with information about campaigns currently being run by the DSP 25. The demand-side platform applies logic configured within each campaign configured on the DSP 25 to determine whether to bid for an ad slot and how much to bid. Next, if the DSP 25 decides to bid, the DSP 25 returns a bid response to the SSP 22 via the exchange 24.

The SSP 22, upon receiving bid responses from one or more DSPs 25 conducts an auction process to determine a winning bid. The SSP 22 subsequently returns content, such as an image, from the winning DSP 25 to the publisher 21 to serve to the user within the webpage. The above described process is very quick, taking place over a fraction of a second, so that the content for the ad slot can be obtained and included in the webpage without undue delay to the user that requested the webpage.

The information provider 23 mentioned above provides information to the SSP 22 that indicates a classification of the content of the webpage. This classification is then included in the bid request sent to the DSP 25. A method of classifying the content of a webpage will be described in greater detail below after an alternative implementation is described.

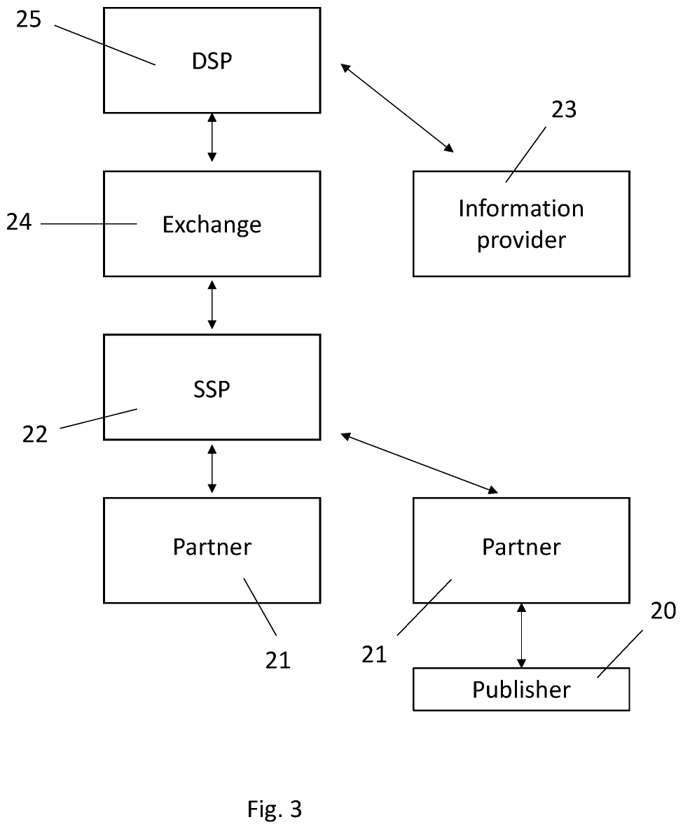

FIG. 3 shows an alternative implementation of a system for placing content in which the information provider 23 provides information to the DSP 25 rather than the SSP 22. In the system shown in FIG. 3, the information provider 23 is not involved until a bid request is received at the DSP 25. Upon receiving the bid request, the DSP 25 applies logic to determine if it wants to bid for an ad slot. The logic applied by the DSP 25 in this implementation includes a step of identifying the type of subject matter associated with the web page and comparing it with a desired subject matter configured within the campaign. In order to make this comparison, the DSP 25 sends a request to the information provider 23 including parameters of the URL for the webpage, which URL is included in the bid request from the SSP 22, and a subject matter category or subcategory to be queried against. The subject matter category or subcategory is selected from within a taxonomy as will be described later. The information provider 23, upon receipt of the request, performs a method for classifying the content within the webpage 1 and returns a Boolean value indicating whether or not the webpage content matches the category or subcategory included in the request. In other implementations, the information provider 23 may return a percentage match against the subject matter category or subcategory rather than a Boolean value.

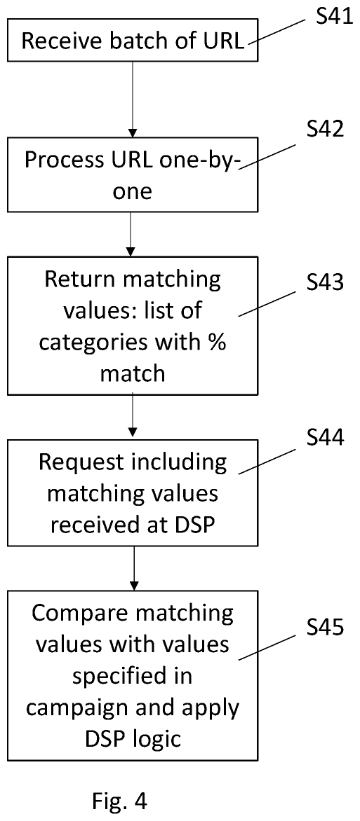

FIG. 4 is a flowchart showing steps in connection with FIG. 2 in which the information provider 23 communicates with the SSP 22. In step S41, the information provider 23 receives a batch of URLs from the SSP 22. The SSP 22 sends a batch of URLs rather than an individual URL for efficiency. The information provider 23 caches the received URLs into a queue and processes the URLs one-by-one in S42 to classify the content of the webpages. The classification method will be described in greater detail below. In step S43, the information provider returns to the SSP 22 classifications for the content of the webpages at each of the received URL. The classification includes a list of subject matter categories or subcategories in one or more taxonomy and a percentage match of the webpage against some or all categories or subcategories in the taxonomy. In step S44, the SSP 22 sends a bid request to the DSP 25 including the URL, user information and the classification information received from the information provider 23. In step S45, the DSP, having received the bid request, uses the classification information when applying logic to decide whether or not to bid to place content in a campaign. For example, a campaign for travel insurance may require that content is only placed in webpages with a high classification score for the subject matter category ‘holidays’.

The information provider 23 may cache the results of classifications for a webpage after they have been calculated in response to a request from an SSP. The reason for this is that, in general, there may be more than one SSP 22 and so the information provider 23 may receive a request for a webpage more than once. Alternatively, the same SSP 22 may make multiple requests for the same webpages over time, which again will see repeated requests for classification of the content of the same webpage. Accordingly, the information provider 23 may cache the results of classification and may check the cache to see if a webpage has been previously classified before proceeding to perform the classification method.

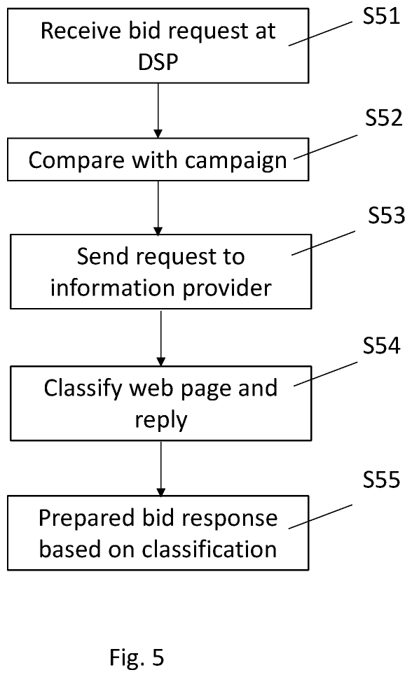

FIG. 5 is a flowchart showing steps performed in the system for placing content shown in FIG. 2 in which the information provider 23 communicates with the DSP 25. In step S51, a bid request is received at the DSP 25 from the SSP 22. In step S52, the DSP 25 applies logic to compare information about the ad slot with criteria for campaigns that are currently configured on the DSP 25. The logic within a campaign may include logic regarding categories of webpage that the campaign content should be placed within. In such cases, the DSP 25 sends a request in step S53 to the information provider 23 to determine whether the content in a webpage matches a specific category or subcategory in a taxonomy. The taxonomy used by the campaign is the same as a taxonomy used by the information provider 23. Upon receiving the request, the information provider 23 classifies the webpage in step S54 and returns a Boolean value to the DSP 25 indicating whether or not the webpage matches the category or subcategory included in the request from the DSP 25. In step S55, the DSP 25 completes the logic for analysing the bid request and sends a bid response to the SSP. The decision logic applied by the DSP 25 takes into account the value returned from the information provider 23.

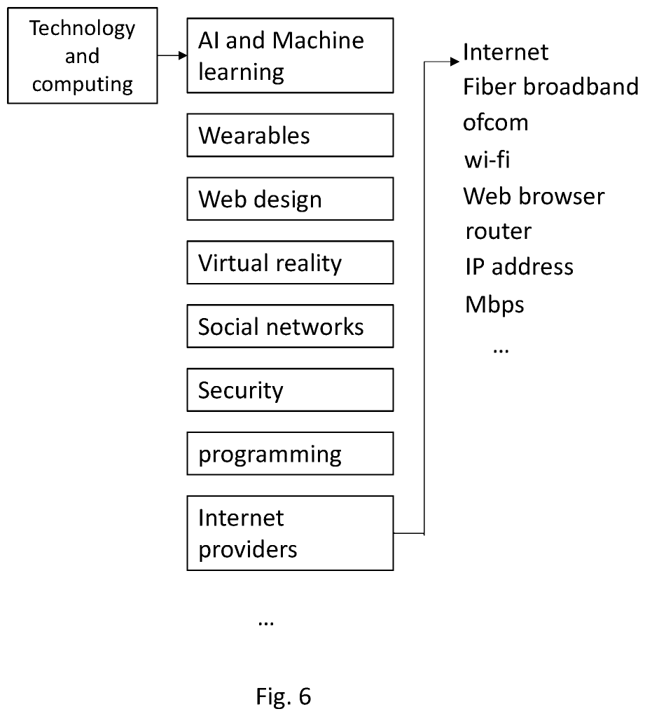

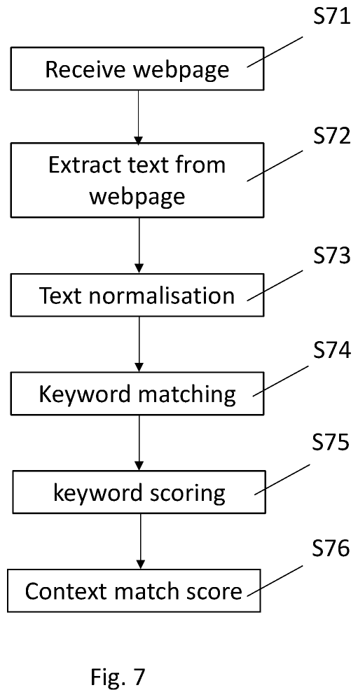

Methods of classifying text content of a webpage performed by the information provider 23 will now be described using FIGS. 6 and 7.

FIG. 6 shows a portion of a taxonomy against which webpages are matched in the processes described above. As noted previously, a common taxonomy is stored both at the DSP 25 and the information provider 23. At a top level of the taxonomy there are provided several categories, such as food and drink, technology and computing etc. Within each category at the top level of the taxonomy there are provided one or more subcategories. For example, as shown in FIG. 6, within the ‘technology and computing’ category' there are provided several subcategories including AI and machine learning, wearables, web design, virtual reality, social networks, security, programming and internet providers. This list is not exhaustive and further subcategories may be included. Within each subcategory a set of keywords is defined. Keywords for the subcategory ‘internet providers’ are shown in FIG. 6 and these include internet, fibre broadband, Ofcom, wi-fi, web browser, router, IP address, Mbps etc. Again, this list of keywords is not exhaustive. Keywords are provided for each subcategory. Collectively the set of categories, subcategories and keywords form a taxonomy.

FIG. 7 is a flow chart showing a method for classification of text content within a webpage used by the information provider 23. For ease of explanation, an example will be described in which a webpage includes only text content and is received in step S71 at the information provider 23 either in a request from the SSP 22 in the implementation explained previously with reference to FIGS. 2 and 4 or in a request from the DSP 25 in the implementation explained previously with reference to FIGS. 3 and 5.

In step S72, text is extracted from the webpage. This may be done using an HTML parser, such as BeautifulSoup parsing library in Python® programming language. The HTML parser allows HTML tags, footers, side bars, navigational links and other HTML artefacts to be removed from the webpage and the text content to be recovered.

In step S73 a process of text normalisation is performed. In this process, the text extracted in step S72 is normalised to remove punctuation and make all text lower case. The text is then stemmed using a stemmer, such as Snowball Stemmer. The purpose of stemming is to remove morphological affixes from words. For example, ‘rolling’ may be stemmed to ‘roll’ and ‘responded’ may be stemmed to ‘respond’.

In step S74 keyword matching is performed. The normalised text is checked against the list of all keywords that is stored within the taxonomy regardless of the subcategory that the keywords are stored under. This process identifies keywords within the text content.

In step S75 a step of keyword scoring process assigns an importance score to each of the identified keywords from step S74. The assigned importance score is determined based on a word's frequency within the text content from the webpage and the word's rarity in the wider lexicon. For example, if the word ‘holiday’ appears five times within the text content, there is a higher likelihood that the content from the webpage relates to holidays than if ‘holiday’ only appears once. A more frequently occurring keyword is assigned a higher score accordingly. Similarly, keywords that appear rarely in general language and usually only in a particular subject matter context will be scored more highly. For example, the word ‘windscreen’ may receive a relatively high importance score because it relates to automobiles and rarely appears in other contexts. The above factors are taken into account by using term frequency-inverse document frequency (tf-idf). The inverse document frequency (or rarity in the wider lexicon) is determined by extracting keywords from a subset of all Wikipedia® articles and determining a fraction of articles that contain the keyword.

In step S76 a context match score is calculated in order to classify the subject matter of the content. The importance scores of keywords found within the text content within each subcategory are additively combined and then scaled to be bound between 0 and 1 using a tuned tanh function to generate the context match score for a subcategory or category within the taxonomy. The context match score value provides an indication of the extent to which the content matches against each subject matter subcategory or subcategory within the taxonomy.

The indication sent out to the SSP 22 in step S43 described above, is a list of categories and subcategories with a context match score value given by the tuned tanh function as described above.

In the alternative implementation previously described, the response sent by the information provider in step S54 to the DSP 25, is a Boolean value indicating whether or not the webpage matches a particular subcategory. The Boolean value is determined by comparing the context match score for the requested category or subcategory against a threshold, such as 0.7 and if the context match score is above that threshold the Boolean value is 1—there is a match—and if the context match score is below the threshold the Boolean value is 0—there is no match.

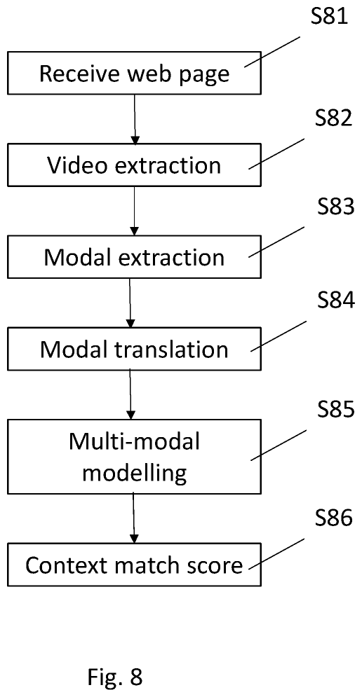

FIG. 8 is a flowchart showing steps performed by the information provider 23 for processing video content within a webpage. Video content may be included within a webpage on its own or with other content, such as text content. If both types of content are present, the above-described process for processing text content is used for the extracted text content and the following process is used for the video content.

In step S81 the webpage is received. In step S82, video content is extracted from the webpage with audio included. In some embodiments this may be achieved using youtube-dl which is an open source tool for downloading videos from a webpage.

In step S83 a step of modal extraction is performed in which the video is broken down into video images and an audio track. In embodiments where youtube-dl is used, the audio is already provided as a separated audio track.

The video images are processed in order to identify keyframes. Keyframes are images within the video images that provide unique information and are not very similar to other images in the video. Images that are not keyframes are discarded. By focussing on the keyframes within the video images, the processing required to perform subsequent steps of the method can be significantly reduced. Keyframe identification can be performed using known software, one example of which is ffprobe which is a tool for analysing multimedia streams.

In step S84 modal translation is performed by translating the audio and images to text. For the audio track the modal translation involves speech recognition. There are many options for performing speech recognition available, but some embodiments use CMUSphinx or Kaldi API, which are open source speech recognition programs. Once a transcript of the speech has been obtained, the speech is subjected to the same text normalisation, keyword matching and keyword scoring processes as described above in connection with steps S73, S74 and S75.

The keyframes of the video images are processed using computer vision models. Different computer vision models can recognise different things with differing accuracy. Accordingly, in one implementation, six computer vision models are used to recognise objects within the video images. A first model is Yolov3, which is a convolutional neural network-based image recognition program capable of locating and identifying many common objects. A second computer vision model is darknet53, which is another convolutional neural network-based computer vision program capable of recognising a wider range of objects that Yolov3. A third computer vision model is a VGG16 convolutional neural network trained on Places365, which is a convolutional neural network trained to recognise scenes, such as a sunset, a beach, a forest etc. A fourth computer vision model is ‘the world's simplest face recognition library’ published by Adam Geitgey (https://github.com/ageitgey/face_recognition), which is a face recognition program designed to detect faces. A fifth computer vision model is provided to detect logos within a keyframe. The fifth computer vision model is based on SIFT (scale-invariant feature transform). The sixth computer vision model is Nudenet, which is an open-source convolutional neural network that uses the Resnet50 architecture to detect varying degrees of nudity in images. Other computer vision models may be added to this set or computer vision models removed. For example, a computer vision model for recognising violent content may be added.

The four computer vision models generate recognised objects, which are used as keywords and are subject to keyword matching, S74, and keyword scoring, S75 as described above in connection with FIG. 7.

In step S85, a step of multi-modal modelling is performed to combine the importance scores of the keywords output from the computer vision models and the speech recognition on the audio track. In one implementation, this works simply by performing an additive process with the importance scores in cases where the same keyword is obtained from multiple sources. The additive process may be a weighted combination of the importance scores of the keywords, with the weights determined depending on whether the words were found in the video images or audio track. In other embodiments, all the keywords may be weighted in dependence upon whether they were obtained from the video images or audio track.

In some embodiments, the importance of objects recognised from the video images may be adjusted based on a confidence value from the computer vision model that recognised the object. Accordingly, objects that are only recognised with low confidence are assigned a lower importance value. Similarly, the speech recognition program may provide a confidence score that can be used in determining an importance value of words recognised from the audio track.

A further implementation of S85 may involve using a custom trained word embedding model to adjust confidence values from the computer vision models and/or speech recognition program before determining an importance score for combinations of keywords identified in the audio track and video images. A word embedding model is a model that maps words or phrases to vectors. The use of such a word embedding model allows a similarity between words to be determined. The similarity of words obtained from the audio track and the video images may be compared and confidence values from the computer vision models and/or speech recognition program may be adjusted depending on similarity with other words that have been detected. For example, it may be that the image recognition models will sometimes incorrectly identify planets in a video as either marbles or lamps. In such a case, there may be several candidates for the object recognition output from nodes of the image recognition models (neural networks) including planets, marbles, lamps. The speech recognition on the audio track may be more likely to correctly identify keywords such as ‘space’ or ‘planet’. In this example, by comparing the keywords from the speech recognition with the candidate objects from the image recognition using the word embedding model, a confidence score assigned to planets by the image recognition model can be adjusted up and the confidence scores for the marbles and lamps decreased. The adjusted scores are then used to determine the importance score. For example, in the example above, the keywords ‘marble’ and ‘lamp’ may be given very low importance scores based on the reduced confidence scores.

Once the importance scores have been allocated to the keywords, context match scores are calculated in step S86 in the same way as described in connection with step S76 above, using additive combination and a tuned tanh function.

Logic processing at the DSP 25 and brand safety will now be discussed. As briefly mentioned earlier, the DSP 25 applies logic to information in the bid request in order to decide whether to bid on an ad slot and separately applies heuristics to determine how much to bid for the ad slot. The logic may take the form of a decision tree that the DSP 25 follows to determine whether or not to make a bid for an ad slot in connection with a campaign. In order to carry out these processes, a campaign is configured by a customer at the DSP 25. The configuration at the DSP 25 includes various information, of which the following is a typical example.

The customer configures the DSP 25 with a budget, which is the total amount that the DSP 25 may automatically spend on ad slots for the campaign. The customer will also configure a campaign window, which is a time period during which the campaign runs and during which the DSP 25 may purchase ad slots to place content in for that campaign. The customer will also provide the DSP 25 with content, which is to be provided to the SSP 22 for use in the ad slots that the DSP 25 is successful in purchasing. This content corresponds to the content that the website viewer will eventually by presented with. The customer may also set a maximum bid price, which is the maximum amount that the DSP 25 should pay for an ad slot and may specify categories from the taxonomy described above in connection with FIG. 6 that the content should appear in connection with.

The customer may also specify brand safety categories. These categories, which exist within the taxonomy, are categories which if present in webpage content will prevent the DSP 25 from bidding for that ad slot. The brand safety categories may include categories of subject matter where the customer does not want the content to appear, such as for example drug-related content. Additionally, categories may be included within the taxonomy, such as ‘expletives’ that includes various socially unacceptable words or phrases, that the customer may not wish their content to appear in connection with.

When a customer generates a campaign, the customer may not find that the taxonomy includes exactly the terms or concepts that the customer wishes to use to place content within ad slots. In this case, the customer may create a custom taxonomy, which can be synchronised between the DSP 25 and the information provider 23. In a simple implementation, additional categories, subcategories and keywords may be manually added to the taxonomy in order to include a subject that the customer wishes to advertise against.

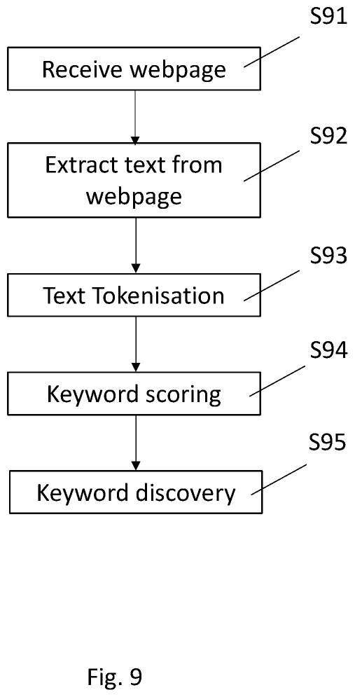

In other implementations, the custom taxonomy may be automatically generated or key words may be automatically generated before being manually selected for addition to the taxonomy. A customer may wish to generate keywords for use in a taxonomy from webpages that the user considers to be suitable for hosting the user's content. A method of extracting keywords from webpages is shown in the flow chart of FIG. 9.

In step S91 a webpage is received that has been selected as a source for keywords. In step S92, text is extracted from the webpage. This may be done using an HTML parser, such as BeautifulSoup parsing library in Python® programming language. The HTML parser allows HTML tags, footers, side bars, navigational links and other HTML artefacts to be removed from the webpage and the text content to be recovered.

In step S93 the text is tokenised by breaking up the plain text into tokens and keywords are identified using Natural Language Took Kit (NLTK), which is a natural language processing library. The process of tokenisation breaks the larger quantity of extracted text into smaller parts, referred to as tokens. Once broken down into individual tokens, typically consisting of single words, part-of-speech tagging is applied to determine nouns, pronouns, adjectives, punctuation, etc.

A chunking process is then applied to the tagged words using a static grammar (a static mapping that is configured in advance) that attempts to combine terms into single tokens wherever it is natural to do so. All punctuation is then removed. All terms are then lemmatised, removing any suffixes. An advantage of lemmatisation rather than stemming the words is that the result is a list of terms of that appear in dictionary and so are human readable. All tokens are lowercased. Finally, stop words (“the”, “and”, “a”) are filtered out since they are of little value in discriminating webpage content.

In step S94, the keywords are scored to identify the most promising keywords. As previously described, a keyword's score is derived from the keyword frequency and rarity in the wider lexicon using TF-IDF. The inverse document frequency is determined by examining the frequency that the keyword appears in articles from a subset of articles on Wikipedia®.

In step S95, the keywords are presented back to a user with the associated importance score. This allows a user to select appropriate keywords for use in a custom taxonomy based on the content of webpages that were selected as containing appropriate subject matter for a campaign.

The above embodiments are to be understood as illustrative examples of the invention. Further embodiments of the invention are envisaged. In the examples above, text extraction from a webpage is described in connection with step S72 of the method for determining the subject matter of text content, in which the text is extracted using an HTML parser. In other implementations, different techniques may be used to extract text content depending upon the type of webpage. Webpages are often constructed using similar structures that make use of similar or identical sections of code. Such similar structures are sometimes referred to as boilerplates. Text content may be extracted in a dynamic manner, rather than using the same approach for each webpage, if common webpage boilerplates are identified and the best ways of extracting text from those webpages are identified. This information can then be used with machine learning techniques to dynamically select and apply an appropriate method for extracting text from each webpage.

In the embodiments above, a method is described in connection with step S85 in which instances of keywords from the audio track and video images are analysed in combination. In further embodiments, when analysing webpages including both text content and video content, keywords from the video may be analysed in combination with keywords from the text. There are several possible approaches for combined analysis of the keywords. One is to use a semantic model in which various combinations of keywords from the text and video are logically combined according to predefined logic in order to generate predefined keyword importance scores. For example, sports pages may frequently contain text, including keywords relating to sport, and a video that is an interview with a player or manager. In this case, the combination of sports keywords in the text in combination with recognition of people in the video may be configured within the semantic model to provide strong keyword importance score values for sport and sport related words. Another approach, instead of using a preconfigured semantic model, would be to identify a number of combinations of keywords from text content and keywords from video content and to have a user correctly classify the importance of the keywords within the webpages and then use this data to apply machine learning techniques to automatically generate keyword importance values from combinations of keywords from video and text content.

The taxonomy described in the embodiments so far has been created manually with users entering categories, subcategories and keywords in accordance with their needs. Methods for automatically suggesting keywords to facilitate the creation of the taxonomy have also been described. In further embodiments, a topic modelling approach may be applied to automatically generate topics for the taxonomy from a collection of documents. Latent Dirichlet allocation (LDA) and LDAvec are statistical approaches to generating topic terms from a document or collection of documents. NETL is a program that labels a group of topic terms with a topic based on machine learning approaches and Wikipedia document titles as label candidates. For example, the topic terms church, archway, building, window, gothic, nave may be identified by LDA from a particular document or website and the label candidate ‘church architecture’ may be generated by NETL. Such an approach may allow the automatic generation of a taxonomy including categories, subcategories and keywords from a selected collection of documents.

In the embodiment described above, the context match scores are calculated by additively combining importance scores of keywords found within the text or video content within each category or subcategory and then scaling the combination to be bound between 0 and 1 using a tuned tanh function to generate the context match score for a subcategory or category within the taxonomy. In other embodiments, a BERT (Bidirectional Encoder Representations from Transformers) MNLI (multi-natural language interference) model may be used to determine the prevalence of a context given the list of keywords determined from the webpage content. Such models were described by Jacob Devlin et al in their paper ‘BERT: Pre-training of Deep Bidirectional Transformers for Language Understanding’, arXiv:1810.04805. An overall topic of a category or sub-category is provided to the BERT MNLI model along with the keywords. The BERT MNLI has been trained on the concept of premises and can identify the prevalence of the selected topic in the collection of keywords. The prevalence is then returned as the context matching score without the need for a category or sub-category that already includes keywords. In some implementations, the keywords that the BERT MNLI identifies as related to a particular topic can be used to construct a category or sub-category containing keywords. In this way the BERT MNLI can be used to generate a taxonomy. The taxonomy generated in this way may be used as previously described to identify the context using the tuned tanh function in place of using BERT MNLI.

In other implementations, a BART MNLI model may be used in place of the BERT MNLI model. Such implementations may achieve better performance. The BART MNLI model is described in the paper BART: Denoising Sequence-to-Sequence Pre-training for Natural Language Generation, Translation, and Comprehension, by Mike Lewis et al at Facebook® AI and published by them.

In further embodiments, the relationship between categories, subcategories and keywords may be encoded into a navigable structure, such as an ontology. Various software programs are known for constructing navigable structures, such as programs known from the field of Ontology learning.

In other embodiments, further sources of data may be used to generate keywords, subcategories and categories for a taxonomy. One option is to use a ‘social listening’ approach in which a social media service, such as Facebook®, is accessed to collect context information relating to occurrences in which a brand is mentioned. This data from the social media service may include a collection of keywords that could be processed similarly to the methods described above to generate keywords to be manually selected or automatically populated into a taxonomy. Another source of data for generating keywords, for example for a brand campaign, is to extract information on websites visited by visitors to a website using an analytics service, such as Google® Analytics. Such services may provide information on webpages that visitors to a website, such as the brand's website, also visit or which webpages customers have previously engaged with brand content on. These webpages may be selected to be processed for keyword generation as described above in connection with FIG. 9. This allows a user to generate keywords for a taxonomy or for use in defining the logic for the campaign on the DSP 25. A further source of data for keywords is a customer information system that holds information about existing customer data.

In further embodiments, techniques may be employed to expand the text of a webpage that only includes a relatively small amount of text. A problem can arise in attempting to classify the subject matter of a webpage if the webpage only includes a small amount of text content. A technique that may be applied to mitigate this problem is to apply a machine learning model, such as GPT-2 a generative pretrained transformer, to take the text in the webpage as a seed and to expand the text. The expanded text may then be analysed using the techniques described above to classify the subject matter of the webpage.

In further embodiments, the information provider 23 may be configured to assist a user in selecting appropriate categories or subcategories from the taxonomy for use in a campaign. A problem that can occur is that the webpage content that a user has in mind when selecting categories or subcategories may not accurately match with the webpage content that will actually be classified in those categories or subcategories by the information provider 23. In order to address this problem, the user may be invited to select a category or subcategory and the information provider 23 may display one or more webpages that correspond to the selected category or subcategory in response to that selection. In other implementations, the user may select only a top-level categories, such as ‘food and drink’ or ‘sport’ and the information provider 23 may present to the user a series of webpages with the option for the user to include or exclude the webpage from the campaign. In this way, the user may select subcategories within the taxonomy without reference to the taxonomy. This approach may be used to present the user with webpages identified from combinations of sub-categories, which the user may not have thought to consider. This may be helpful in cases in which common combinations of subcategories, such as the combination of sport and celebrity, within the taxonomy select particular common types of webpages. In this way, the user may make subject matter selections whilst being shielded from the underlying complexity in the webpage classification.

In the embodiments described above, the publisher 20, partner 21, SSP 22, exchange 24, DSP 25, Brand/Advertiser 26 and information provider 26 described above may each be implemented as a program comprising instructions running on an information processing apparatus. Examples of an information processing apparatus include, without limitation, one or more servers or a cloud computer platform. The information processing apparatus may comprise a memory, a processor and a communication I/O connected by a bus. The communication I/O may be any suitable network connection for communicating between devices, such as a modem for connecting to the internet. The information processing apparatus may further comprise other hardware such as a display, user interfaces such as a mouse and/or keyboard or other hardware as is well known in the art. The program is stored in the memory and may be executed by the processor.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method performed by an information processing apparatus for classifying subject matter of content in a webpage comprising:
receiving a webpage;
extracting content from the webpage;
identifying keywords from the extracted content, wherein the keywords are also contained in a taxonomy stored by the information processing apparatus that associates the keywords with categories of subject matter;
assigning an importance score to the keywords identified from the extracted content;
calculating context scores associated with categories or subcategories of subject matter within the taxonomy based on the importance scores of the identified keywords;
and classifying the content as being associated with one or more category or subcategory of subject matter based on the context scores.

2. A method according to claim 1, wherein the content in the webpage includes text and the method further comprises a step of normalising the text.

3. A method according to claim 1 wherein the step of extracting content from the webpage comprises extracting text content from the webpage using one of a plurality of methods for extracting content from the webpage, the method for extracting text content from the webpage being selected from the plurality of methods for extracting content using a machine learning model based on a type of webpage structure.

4. A method according to claim 1, wherein the content in the webpage includes video data and the method further comprises separating audio data and visual data from the video and the step of identifying keywords using the extracted content comprises extracting keywords from the audio data using speech recognition and extracting keywords from the visual data using image recognition.

5. A method according to claim 4, wherein the step of calculating context scores comprises calculating context scores for the webpage based on importance scores of keywords, which keywords include keywords extracted from the audio data and keywords extracted from the visual data.

6. A method according to claim 5, wherein the context scores are calculating from a weighted combinations of importance scores of keywords associated with the visual data and the audio data.

7. A method according to claim 5, wherein keyword importance scores are calculated based on confidence scores from at least one of a speech recognition program that is used to extract keywords from the audio data and an image recognition program that is used to extract keywords from the visual data.

8. A method according to claim 1 wherein the webpage includes both video content and text content and wherein instances of keywords extracted from both the video content and the text content are analysed in combination to generate an importance score for the keywords.

9. A method according to claim 1 further comprising the step of generating the taxonomy, wherein the step of generating the taxonomy comprises a step of automatically extracting keywords from one or more data sources.

10. A method according to claim 9, further comprising a step of displaying keywords extracted from one or more data sources to a user to enable selection of keywords to be added to the taxonomy.

11. A method according to claim 9, further comprising automatically populating a taxonomy with keywords and categories or subcategories based on keywords extracted from the one or more data sources.

12. A method according to claim 9, further comprising a step of expanding the content of a data source using a generative transformer, wherein automatically extracting keywords from the one or more data source comprises automatically extracting keywords from the expanded content of the data source.

13. A method according to claim 1 further comprising a step of sending a signal including an indication of the subject matter classification to at least one of a demand-side platform and a supply-side platform within a system for automated placement of digital content within webpages.

14. An information processing apparatus for classifying subject matter of content in a webpage, wherein the information processing apparatus comprises:
at least one processor;
and at least one memory including computer program code;
the at least one memory and the computer program code being configured to, with the at least one processor, cause the information processing apparatus to:
receive a webpage;
extract content from the webpage;
identify keywords from the extracted content, wherein the keywords are also contained in a taxonomy stored by the information processing apparatus that associates the keywords with categories of subject matter;
assign an importance score to the keywords identified from the extracted content;
calculate context scores associated with categories or subcategories of subject matter within the taxonomy based on the importance scores of the identified keywords;
and classify the content as being associated with one or more category or subcategory of subject matter based on the context scores.

15. A non-transitory computer-readable storage medium storing a program that, when executed by an information processing apparatus, causes the information processing apparatus to perform a method for classifying subject matter of content in a webpage comprising:
receiving a webpage;
extracting content from the webpage;
identifying keywords from the extracted content, wherein the keywords are also contained in a taxonomy stored by the information processing apparatus that associates the keywords with categories of subject matter;
assigning an importance score to the keywords identified from the extracted content;
calculating context scores associated with categories or subcategories of subject matter within the taxonomy based on the importance scores of the identified keywords;
and classifying the content as being associated with one or more category or subcategory of subject matter based on the context scores.
